(19) United States
(12) Patent Application Publication
(10) Pub. No.: US 2013/0041704 A1
(43) Pub. Date: Feb. 14, 2013

(54) INITIATIVE CONSOLIDATION MANAGEMENT

(71) Applicants: Claudette Girard, Middlebury, CT (US); Ashwin B. R. Kumar, Tamil Nadu (IN); Sayee Ram Prasad Balasubramanian, Tamil Nadu (IN)

(72) Inventors: Claudette Girard, Middlebury, CT (US); Ashwin B. R. Kumar, Tamil Nadu (IN); Sayee Ram Prasad Balasubramanian, Tamil Nadu (IN)

(73) Assignee: BANK OF AMERICA CORPORATION, Charlotte, NC (US)

(21) Appl. No.: 13/207,789

(22) Filed: Aug. 11, 2011

(51) Int. Cl. G06F 17/30; G06Q 10/00

(52) U.S. Cl. 705/7.11; 707/776; 707/E17.014

(57) ABSTRACT

Methods, computer readable media, and apparatuses for managing initiative consolidation are presented. According to one or more aspects, information about at least two new projects may be received. Subsequently, the information may be analyzed to identify one or more commonalities between the at least two new projects. Thereafter, it may be determined, based on the identified commonalities, to bundle the at least two new projects for one or more testing phases. In one or more arrangements, receiving information about the at least two new projects may include extracting, from one or more project design documents, a job listing for each project, where each job listing identifies one or more jobs included in each project. In some arrangements, a cost-benefit analysis may be generated to calculate potential savings associated with bundling the at least two new projects for the one or more testing phases.

### TECHNICAL FIELD

One or more aspects of the disclosure generally relate to computing devices, computing systems, and computer software. In particular, one or more aspects of the disclosure generally relate to computing devices, computing systems, and computer software that may be used by an organization, such as a financial institution, or other entity in managing initiative consolidation.

### BACKGROUND

Large organizations, such as financial institutions, collect and analyze increasingly large amounts of information, including historical transaction data, market trends, customer spending patterns, and so on. In addition, such organizations, implement various models and other analytical functions that draw on such information in order to provide such organizations with greater insight into their businesses. Aspects of the disclosure provide more convenient, functional, and efficient ways of managing how new initiatives, such as data analysis projects, may be developed and deployed by an organization, such as a financial institution.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to methods, computer-readable media, and apparatuses for initiative consolidation management. For example, an organization, such as a financial institution, may gather various information about customers, such as transaction history information, demographic information, personal information, and so on. In addition, such an organization may use various data processing algorithms and other processes to analyze such information and compute various results, such as trends in customer spending patterns, models of customer behavior, and so on. As such an organization grows in size, increasingly large amounts of data may be stored and analyzed, greater numbers of algorithms may be used, and a growing number of new projects and algorithms may continue to be developed and deployed. As new projects and algorithms are developed and deployed, however, various types of testing might need to be conducted, and in some instances, similar testing may be performed with respect to different projects and initiatives. By implementing one or more aspects of the disclosure, an organization, such as a financial institution, may be able to streamline testing processes and thereby realize significant cost savings when developing and deploying new projects and initiatives.

According to one or more aspects, information about at least two new projects may be received. Subsequently, the information may be analyzed to identify one or more commonalities between the at least two new projects. Thereafter, it may be determined, based on the identified commonalities, to bundle the at least two new projects for one or more testing phases.

In one or more arrangements, the identified commonalities may include one or more common data inputs and/or one or more common data outputs. In some arrangements, receiving information about the at least two new projects may include extracting, from one or more project design documents, a job listing for each project, where each job listing identifies one or more jobs included in each project.

In other arrangements, analyzing the information to identify one or more commonalities between the at least two new projects may further include determining, based on the job listing for a first project of the at least two new projects, that a first set of data tables are used as inputs for the first project; determining, based on the job listing for a second project of the at least two new projects, that a second set of data tables are used as inputs for the second project; and comparing the first set of data tables with the second set of data tables.

In still other arrangements, analyzing the information to identify one or more commonalities between the at least two new projects may further include determining, based on the job listing for a first project of the at least two new projects, that a first set of target tables are used as outputs for the first project; determining, based on the job listing for a second project of the at least two new projects, that a second set of target tables are used as outputs for the second project; and comparing the first set of target tables with the second set of target tables.

According to one or more additional aspects, a cost-benefit analysis may be generated to calculate potential savings associated with bundling the at least two new projects for the one or more testing phases, and determining to bundle the at least two new projects may further be based on determining that the calculated potential savings exceed a predetermined threshold.

According to one or more alternative aspects, determining to bundle the at least two new projects may further be based on determining that the number of identified commonalities exceeds a predetermined threshold.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment in which various aspects of the disclosure may be implemented.

FIG. 1B illustrates another example operating environment in which various aspects of the disclosure may be implemented.

FIG. 2 illustrates an example method of managing initiative consolidation according to one or more illustrative aspects described herein.

FIGS. 3-5 illustrate example project development timelines according to one or more illustrative aspects described herein.

FIG. 6 illustrates an example implementation plan for managing initiative consolidation for a define phase of a project according to one or more illustrative aspects described herein.

FIGS. 7A-7C illustrate an example implementation plan for managing initiative consolidation after a define phase of a project according to one or more illustrative aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

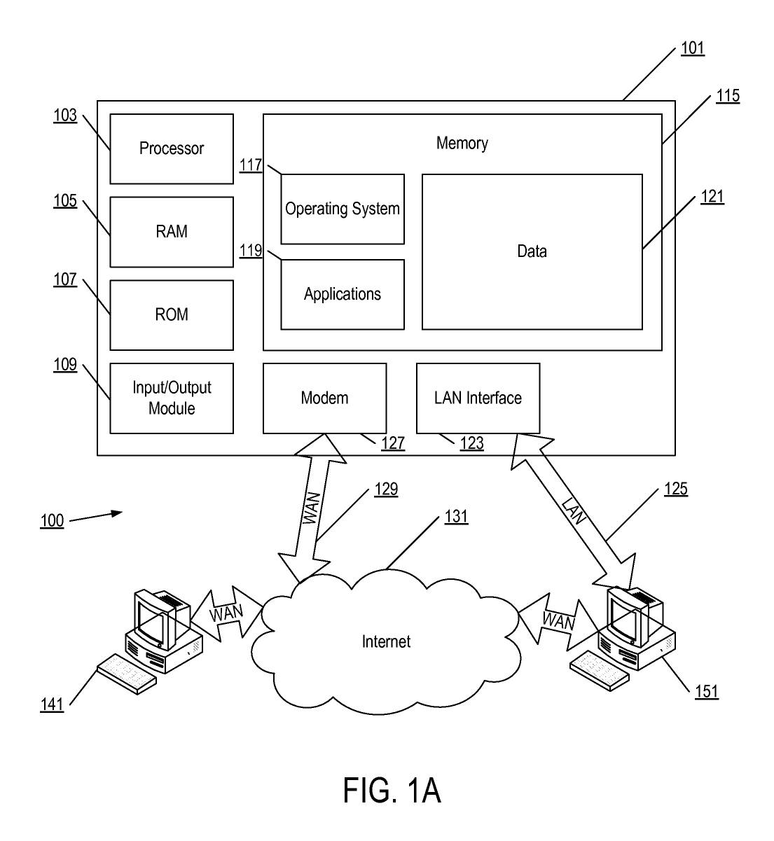

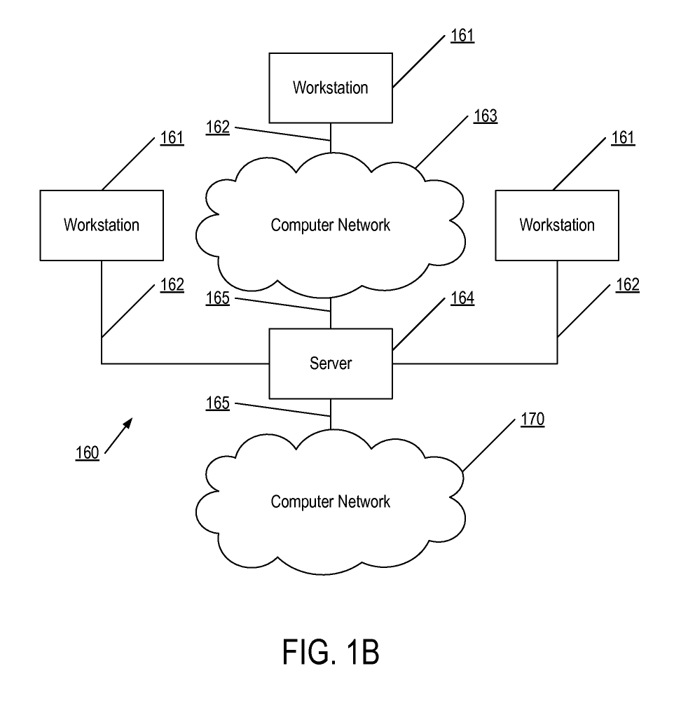

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, etc.) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. As illustrated, system 160 may include one or more workstations 161. Workstations 161 may, in some examples, be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a financial institution, such as a bank. Various elements may be located within the financial institution and/or may be located remotely from the financial institution. For instance, one or more workstations 161 may be located within a branch office of a financial institution. Such workstations may be used, for example, by customer service representatives, other employees, and/or customers of the financial institution in conducting financial transactions via network 163. Additionally or alternatively, one or more workstations 161 may be located at a user location (e.g., a customer's home or office). Such workstations also may be used, for example, by customers of the financial institution in conducting financial transactions via computer network 163 or computer network 170.

Computer network 163 and computer network 170 may be any suitable computer networks including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communications links 162 and 165 may be any communications links suitable for communicating between workstations 161 and server 164, such as network links, dial-up links, wireless links, hard-wired links, etc.

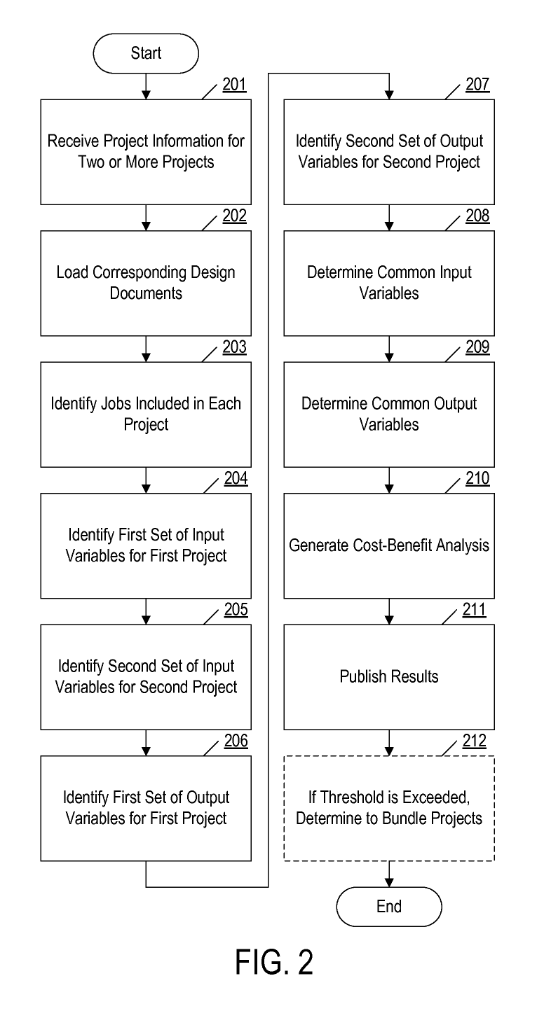

FIG. 2 illustrates an example method of managing initiative consolidation. According to one or more aspects, the methods described herein may be implemented by software executed on one or more computers, such as the generic computing device 101 of FIG. 1A, and/or by a computing system, such as system 160 of FIG. 1B. In at least one arrangement, the methods described herein may be performed by and/or in combination with a server (e.g., server 164). Additionally or alternatively, the methods described herein may be performed by and/or in combination with one or more workstations (e.g., workstations 161).

In step 201, project information for two or more projects may be received. For example, in step 201, a computing device, such as a financial institution's project management system (which may, e.g., implement one or more aspects of generic computing device 101 or system 160) may receive project information for two or more projects, such as a first unique project identifier corresponding to a first project and a second unique project identifier corresponding to a second project. Each unique project identifier may, for instance, be an alphanumeric string of characters used by financial institution's project management system to identify various projects about which information is stored. In one or more arrangements, the project management system may store such information in one or more databases and/or data tables, which in turn may be stored locally in the one or more computing devices making up the project management system and/or remotely from the project management system (but accessible to the project management system, e.g., via a network).

In step 202, design documents corresponding to the two or more projects may be loaded. For example, in step 202, the computing device (e.g., the financial institution's project management system) may access one or more databases and/or data tables in which one or more design documents for each of the two or more projects are stored, and subsequently, the computing device may load (e.g., into memory) information stored in the one or more accessed design documents. According to one or more aspects, such design documents may include detailed information about each project, such as the business requirements each project is designed to satisfy, the input data sources relied upon by each project, the data manipulation algorithms or “jobs” used in each project, and/or the target tables to which processed data is output by each project. The design documents may, for instance, be one or more high-level design documents (HLDs), one or more low-level design documents (LLDs), and/or one or more express project documents (EPDs) that may be used by an organization (e.g., a financial institution) and/or the project management system in managing the development and deployment of one or more data analysis projects. While these forms of project design documents are listed as examples, any other desired project design documents may similarly be accessed and loaded. Additionally or alternatively, a user may manually enter (and the computing device may receive) design information about each of the two or more projects, such as the information that might otherwise be included in the design documents described above, and the computing device may, in step 202, load this manually entered information instead of loading one or more design documents.

According to one or more aspects, a high-level design document (HLD) may be based on significant, finalized, and/or approved business and/or architecture requirements. An HLD may define the logical and/or physical architecture capturing input from supporting processes such as architecture processes, monitoring processes, operations processes, production support processes, and/or any other processes that might be needed to properly describe a systems-based solution for the business and/or its associated architecture requirements. According to one or more additional aspects, a low-level design document (LLD) may be based on a finalized and/or approved HLD. Input into the development of an LLD may, for instance, include supporting processes and/or groups such as architecture processes and/or groups, monitoring processes and/or groups, ECT&O infrastructure processes and/or groups, operations processes and/or groups, production support processes and/or groups, and/or any other processes and/or groups that might be needed to properly describe a detailed technical solution. In at least one arrangement, a completed LLD may include technical design features for all high-level design elements, and/or may be detailed enough to provide the input for the development of the project software. According to one or more additional aspects, an express project document (EPD) may be used for a relatively smaller project. For example, an EPD may include one or more business requirements for the projects, one or more high-level design specifications, one or more low-level design specifications, one or more testing plans and/or testing scripts, and/or one or more implementation plans. In at least one arrangement, an EPD further may include a section in which all the major deliverables associated with the project might be listed.

In step 203, the one or more jobs included in each of the two or more projects may be identified. For example, in step 203, the computing device (e.g., the financial institution's project management system) may compile a listing of the one or more jobs relied upon, executed, and/or otherwise used in each of the two or more projects. Such jobs may include, for instance, one or more data sourcing and/or data lookup functions (which may, e.g., extract source and/or input data from one or more input data tables), one or more data manipulation and/or data transformation functions (which may, e.g., perform mathematical, analytical, and/or other processing on the extracted source and/or input data), and/or one or more data loading functions (which may, e.g., load, into one or more target tables, the results of the processing performed by the data manipulation and/or data transformation functions). In some arrangements, the computing device may compile the listing of the one or more jobs included in each of the two projects in response to receiving a user request, such as a SQL query, to generate such a listing.

In step 204, a first set of input variables for a first project of the two or more projects may be identified. For example, in step 204, the computing device (e.g., the financial institution's project management system) may analyze the one or more jobs included in the first project to determine what input data is relied upon and/or otherwise used by the one or more jobs included in the first project. This may include, for instance, parsing one or more documents in which the jobs are defined (e.g., programming code, function definition documents, etc.) to identify the parameters and/or arguments used by each of the one or more functions making up the jobs.

In step 205, a second set of input variables for a second project of the two or more projects may be identified. For example, in step 205, the computing device (e.g., the financial institution's project management system) may analyze the one or more jobs included in the second project to determine what input data is relied upon and/or otherwise used by the one or more jobs included in the second project, similar to how the computing device may analyze the one or more jobs included in the first project in step 204.

In step 206, a first set of output variables for a first project of the two or more projects may be identified. For example, in step 206, the computing device (e.g., the financial institution's project management system) may analyze the one or more jobs included in the first project to determine what output data is generated by and/or otherwise impacted by the one or more jobs included in the first project. This may include, for instance, parsing one or more documents in which the jobs are defined (e.g., programming code, function definition documents, etc.) to identify the output variables, target tables, and/or other output values generated, modified, and/or otherwise affected by the one or more functions making up the jobs.

In step 207, a second set of output variables for the second project of the two or more projects may be identified. For example, in step 207, the computing device (e.g., the financial institution's project management system) may analyze the one or more jobs included in the second project to determine what output data is generated by and/or otherwise impacted by the one or more jobs included in the second project, similar to how the computing device may analyze the one or more jobs included in the first project in step 206.

In step 208, one or more input variables common to both the first project and the second project may be determined. For example, in step 208, the computing device (e.g., the financial institution's project management system) may compare the first set of input variables for the first project with the second set of input variables for the second project, and subsequently may determine whether any of the input variables of the first set match any of the input variables of the second set. According to one or more aspects, the computing device may determine that an input variable of the first set matches an input variable of the second set when both input variables rely on the same data value loaded from the same data table. In some additional or alternative arrangements, the computing device may determine that an input variable of the first set matches an input variable of the second set when both input variables qualitatively correspond to the same value (e.g., net credit losses during the previous month), but are loaded from different tables (e.g., the first project may load the number or amount of net credit losses during the previous month from a first data table maintained on a first system, while the second project may load the amount of net credit losses during the previous month from a second data table maintained on a second system different from the first system).

In step 209, one or more output variables common to both the first project and the second project may be determined. For example, in step 209, the computing device (e.g., the financial institution's project management system) may compare the first set of output variables for the first project with the second set of output variables for the second project, and subsequently may determine whether any of the output variables of the first set match any of the output variables of the second set. According to one or more aspects, the computing device may determine that an output variable of the first set matches an output variable of the second set when both output variables correspond to the same data value stored in the same data table. In some additional or alternative arrangements, like with the input variables, the computing device may determine that an output variable of the first set matches an output variable of the second set when both output variables qualitatively correspond to the same value (e.g., a forecast of net credit losses in the coming month), but are loaded into different target tables (e.g., the first project may calculate and load a forecast of net credit losses in the coming month into a first data table maintained on a first system, while the second project may calculate and load the forecast of net credit losses in the coming month into a second data table maintained on a second system different from the first system).

In step 210, a cost-benefit analysis may be generated. The cost-benefit analysis may include a projection of cost savings that could be realized if the first project and the second project were bundled for one or more testing phases. According to one or more aspects, projects may be bundled for one or more testing phases by combining the data analysis functions common to each of the projects such that each common data analysis function (e.g., extracting input data from a particular source, transforming data in a particular way, loading output data into a particular table, etc.) might only need to be executed once for all of the projects, rather than multiple times for each project individually. For example, if two projects involve extracting input data, transforming the input data, and/or loading the transformed input data as output data into one or more target tables, then the two projects may be bundled by combining the extracting steps insofar as the two projects extract data from the same input sources, mashing together the transformation steps of the two projects and/or otherwise combining the transformation steps of the two projects where they overlap, and/or combining the loading steps insofar as the two projects output data into the same target tables. Bundling one or more projects also may include otherwise combining the one or more projects so as to obtain efficiencies within one or more testing phases without departing from the disclosure.

For example, in step 210, the computing device (e.g., the financial institution's project management system) may generate a cost-benefit analysis including such a projection. The projection of cost savings may, for instance, be stated in terms of man-hours to be saved during the one or more testing phases and/or in terms of money to be saved during the one or more testing phases.

According to one or more aspects, the computing device may calculate the projection of cost savings based on information extracted from the corresponding design documents of each of the projects. For example, in each project's one or more design documents, an amount of man-hours expected to be used and/or an amount of money expected to be spent on one or more testing phases of the project may be set forth, and the computing device may parse these documents and extract these amounts accordingly. Subsequently, having determined that the two or more projects share at least one or more common input variables and/or at least one or more common output variables, the computing device may determine that if the two or more projects were tested together, only the greater amount of man-hours and/or the greater amount of money (to be used and/or spent with respect to testing, as between the two or more projects) might need to be used and/or spent in testing the two or more projects together. Such savings might be realizable because, for instance, if the two or more projects share one or more common inputs and/or one or more common outputs, the two or more projects may be combined and tested together in the same testing information. Thus, time and/or money may be saved since a testing team might only need to set up a common testing environment once for the two or more projects (instead of once for each of the projects, which would, e.g., result in multiple independent, rounds of testing) and/or otherwise run tests on the two or more projects together and all at once.

In step 211, the results of the cost-benefit analysis may be published. For example, in step 211, the computing device (e.g., the financial institution's project management system) may publish the generated cost-benefit analysis to a web portal where the analysis may be accessed and/or viewed by one or more internal and/or external stakeholders. Additionally or alternatively, the computing device may publish the generated cost-benefit analysis by electronically transmitting the analysis (e.g., via electronic mail) to one or more project managers, project development and deployment coordinators, project team members, and so on.

In optional step 212, it may be determined to bundle the two or more projects if a threshold is exceeded. In some arrangements, the threshold may be a predetermined number of common input variables and/or a predetermined number of common output variables, while in other arrangements, the threshold may be a predetermined number of man-hours saved and/or a predetermined amount of money saved by bundling the projects for one or more testing phases. For example, in step 212, the computing device (e.g., the financial institution's project management system) may determine that the number of common input variables determined in step 208 exceeds a first predetermined threshold and/or may determine that the number of common output variables determined in step 209 exceeds a second predetermined threshold, and subsequently may determine that the two or more projects should be bundled accordingly. As another example, in step 212, the computing device may determine that the number of man-hours to be saved by bundling the two or more projects and/or the amount of money to be saved by bundling the two or more projects, as projected in the cost-benefit analysis, exceeds a predetermined number of hours and/or a predetermined amount of money, respectively, and subsequently may determine that the two or more projects should be bundled accordingly.

In one or more alternative arrangements, the decision to bundle the two or more projects may be made manually by one or more stakeholders, e.g., based on the results of the generated cost-benefit analysis, as further described below. For instance, in some arrangements, after a cost-benefit analysis regarding bundling the two or more projects is generated, various individuals and/or teams may provide input as to whether the two or more projects should be bundled for one or more testing phases. Such individuals and/or teams may include a dedicated project bundling team, one or more portfolio managers and/or portfolio management teams, one or more individuals and/or teams from the one or more lines of business (e.g., internal divisions of the financial institution) that may be developing and deploying the two or more projects, and/or other individuals or teams.

Having described an example method of managing initiative consolidation, several examples of bundling projects will now be described with respect to several example project development timelines.

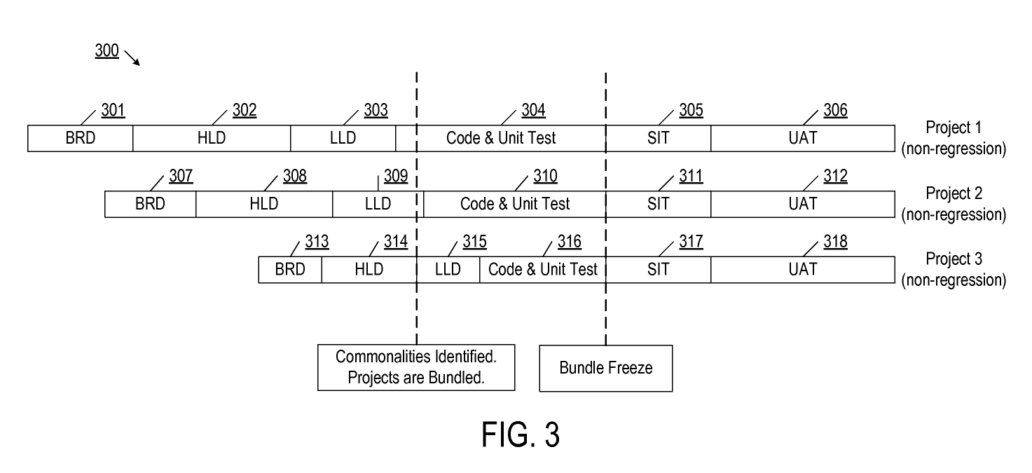

FIGS. 3-5 illustrate example project development timelines according to one or more illustrative aspects described herein. In FIG. 3, example project development timeline 300 shows how three different projects may progress through various stages and at which point the three projects may be bundled. For instance, Project 1 of timeline 300 includes a business requirements document (BRD) phase 301, a high-level design document (HLD) phase 302, a low-level design document (LLD) phase 303, a coding and unit testing phase 304, a system integration testing (SIT) phase 305, and a user acceptance testing (UAT) phase 306.

According to one or more aspects, during the BRD phase 301, a business requirements document may be created for the project and/or stored in a project management system. During the HLD phase 302, a high-level design document may be created for the project and/or stored in the project management system. During the LLD phase 303, a low-level design document may be created for the project and/or stored in the project management system. During the code and unit testing phase 304, development of the software associated with the project and initial unit testing thereof may begin. During the System Integration Testing (SIT) phase 305, the software associated with the project may be tested to evaluate how it performs when integrated with one or more other systems. During the User Acceptance Testing (UAT) phase 306, the software associated with the project may be tested by one or more users to evaluate how well it satisfies one or more business requirements and/or other requirements specified, e.g., in the business requirements document, high-level design document, low-level design document, and/or the like.

Similarly, for example, Project 2 of timeline 300 includes a BRD phase 307, an HLD phase 308, an LLD phase 309, a code and unit testing phase 310, an SIT phase 311, and a UAT phase 312. In addition, Project 3 of timeline 300 includes a BRD phase 313, an HLD phase 314, an LLD phase 315, a code and unit testing phase 316, an SIT phase 317, and a UAT phase 318.

As seen in example timeline 300, the commonalities between the three projects (i.e.,

Project 1, Project 2, and Project 3) may be identified when the high-level design document for Project 3 is completed (as in this example, the high-level design documents for Project 1 and Project 2 have already been completed at that point in time). According to one or more aspects, the commonalities between the projects may be identified and the projects may be bundled at this point (e.g., when the high-level design document for Project 3 is complete) because once a high-level design document is complete for a particular project, the input variables and the output variables used and/or affected by the project may be known (and thus the bundling analysis may be performed).

In addition, as also seen in example timeline 300, once the projects are bundled, the bundled projects may enter and progress through the SIT phase and the UAT phase together, as these phases may be the one or more testing phases for which the projects are bundled. Moreover, the beginning of the SIT phase may be referred to as a “Bundle Freeze” because at that point in time, no other projects may be further bundled with Project 1, Project 2, and Project 3, since these three projects have already entered one or more bundled testing phases. According to one or more aspects, a bundle freeze may be imposed at a point in time (e.g., the beginning of the SIT phase) where bundling the projects results in greater risk to the projects than any potential benefits that might be realized therefrom.

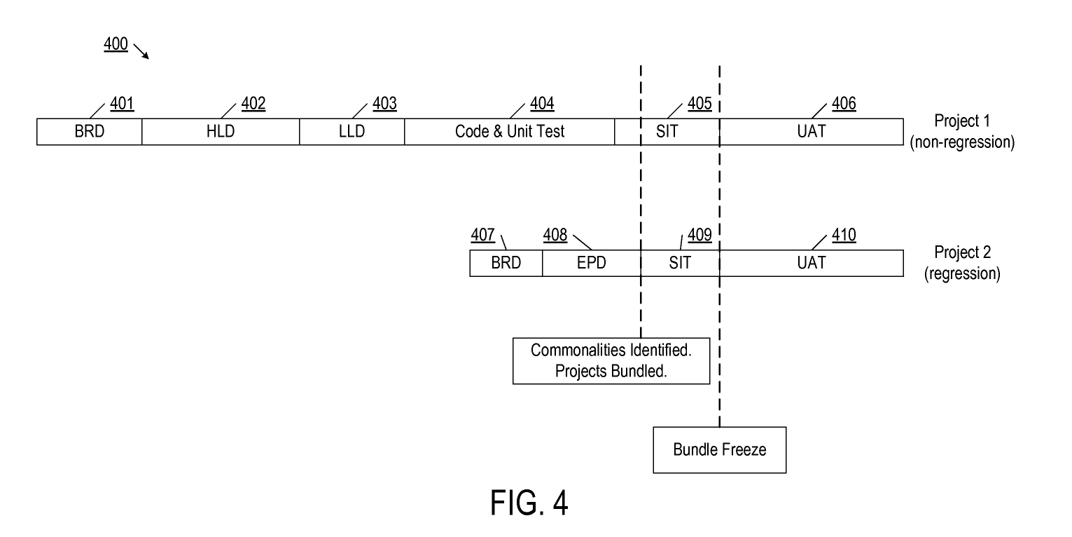

In FIG. 4, example project development timeline 400 shows how a non-regression project (e.g., Project 1) and a regression project (e.g., Project 2) may progress through various stages and be bundled for one or more testing phases. According to one or more aspects, a regression project may be a project that only involves testing (e.g., and no software development or other coding), whereas a non-regression project may be a project that includes a full project lifecycle (e.g., including software development and other coding). For example, Project 1, which may be a non-regression project, may include a BRD phase 401, an HLD phase 402, an LLD phase 403, a code and unit testing 404, an SIT phase 405, and a UAT phase 406. Project 2, which may be a regression project, for instance, might only include a BRD phase 407, an express project document (EPD) phase 408 (e.g., in which an express project document is created to define one or more parameters of the project, instead of a high-level design document and a low-level design document), an SIT phase 409, and a UAT phase 410.

As seen in example timeline 400, the commonalities between the two projects (i.e., Project 1 and Project 2) may be identified when the express project document for Project 2 is completed (as in this example, the high-level design document for Project 1 has already been completed at that point in time). According to one or more aspects, the commonalities between the projects may be identified and the projects may be bundled at this point (e.g., when the express project document for Project 2 is complete) because once an express project document is complete for a particular regression project, the input variables and the output variables used and/or affected by the regression project may be known (and thus the bundling analysis may be performed).

In addition, as also seen in example timeline 400, once the projects are bundled, the bundled projects may enter and progress through the SIT phase and the UAT phase together, as these phases may be the one or more testing phases for which the projects are bundled. Moreover, as was the case in the example discussed above, the beginning of the SIT phase may be referred to as a “Bundle Freeze” because at that point in time, no other projects may be further bundled with Project 1 and Project 2, since these two projects have already entered one or more bundled testing phases.

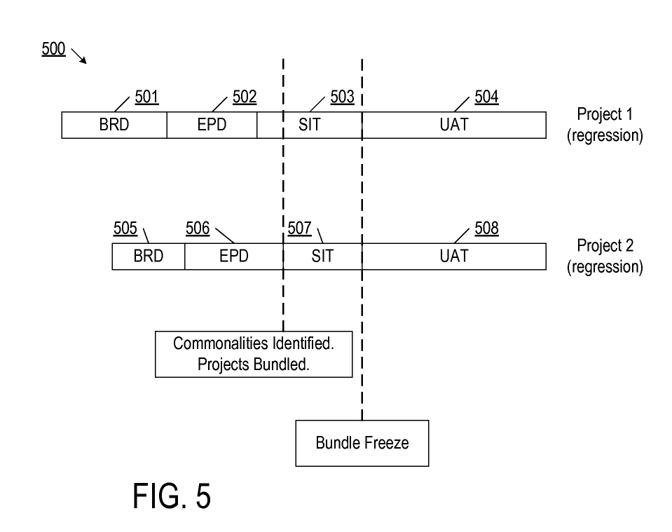

In FIG. 5, example project development timeline 500 shows how two regression projects may progress through various stages and be bundled for one or more testing phases. As noted above, a regression project may be a project that only involves testing (e.g., and no software development or other coding). For example, Project 1 may include a BRD phase 501, an EPD phase 502, an SIT phase 503, and a UAT phase 504. Project 2 may include, for instance, a BRD phase 505, an EPD phase 506, an SIT phase 507, and a UAT phase 508.

As seen in example timeline 500, the commonalities between the two projects (i.e., Project 1 and Project 2) may be identified when the express project document for Project 2 is completed (as in this example, the express project document for Project 1 has already been completed at that point in time). According to one or more aspects, the commonalities between the projects may be identified and the projects may be bundled at this point (e.g., when the express project document for Project 2 is complete) because, as noted above, once an express project document is complete for a particular regression project, the input variables and the output variables used and/or affected by the regression project may be known (and thus the bundling analysis may be performed).

In addition, as also seen in example timeline 500, once the projects are bundled, the bundled projects may enter and progress through the SIT phase and the UAT phase together, as these phases may be the one or more testing phases for which the projects are bundled. Moreover, as was the case in the examples discussed above, the beginning of the SIT phase may be referred to as a “Bundle Freeze” because at that point in time, no other projects may be further bundled with Project 1 and Project 2, since these two projects have already entered one or more bundled testing phases.

Having described several example project development timelines illustrating examples of initiative consolidation management, several example implementation plans for managing initiative consolidation will now be described.

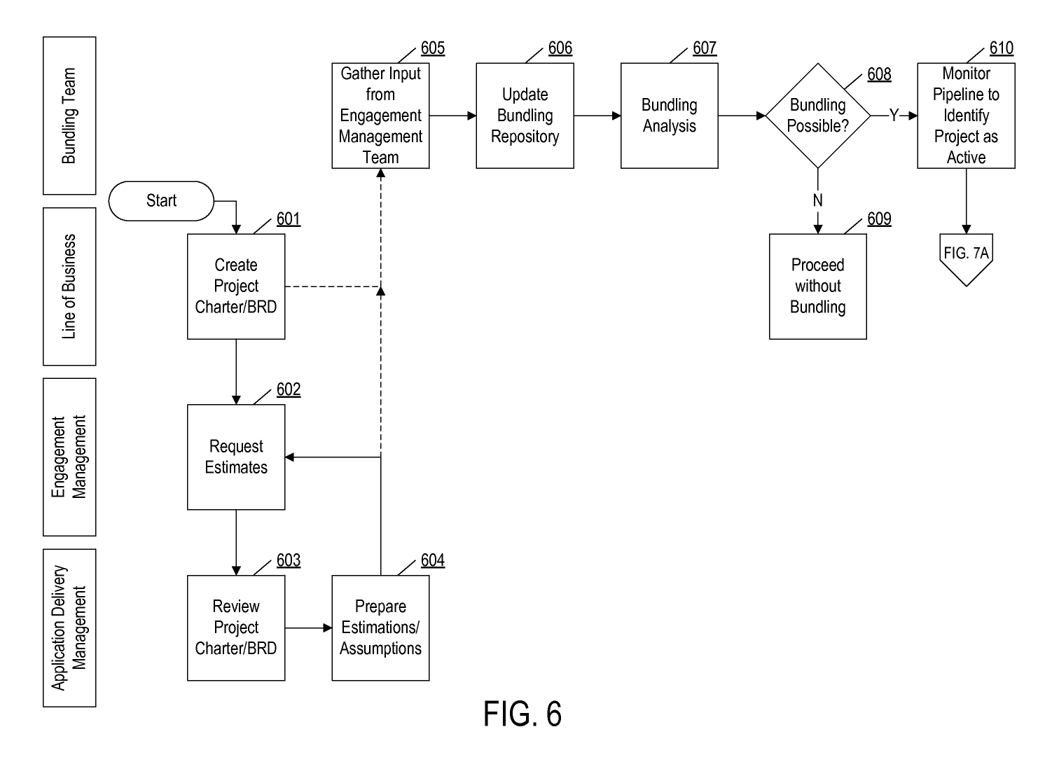

FIG. 6 illustrates an example implementation plan for managing initiative consolidation during a define phase of a project according to one or more illustrative aspects described herein. For example, the example implementation plan may be executed during a “define” phase of a project in which one or more business requirements and/or other requirements of the project are defined. This define phase may be followed by a “measure” phase (e.g., in which one or more aspects of the project and/or its performance are measured), an “analyze” phase (e.g., in which the results of such measurement may be analyzed), an “improve” phase (e.g., in which the project and/or its performance may be improved in view of the analysis), and a “control” phase (e.g., in which the project and/or its performance may be controlled so as to maintain desired performance of the project).

In step 601, a line of business (e.g., an internal division within an organization, such as a financial institution) may create a project charter and/or a business requirements document. The project charter and/or the business requirements document may, for example, set forth the need for a new project and/or the desired features (e.g., business requirements) of such a new project.

In step 602, an engagement management team may request estimates related to the project, such as estimates of resources required, etc. For example, an engagement management team may conduct quick hit meetings with one or more individuals and/or teams from the line of business to estimate various aspects of the project.

In step 603, an application delivery management team may review the project charter and/or the business requirements document, and in step 604, the application delivery management team may prepare a document that includes estimations of various aspects of the project and/or assumptions about various aspects of the project.

Subsequently, in step 605, a project bundling team may gather input from the engagement management team. In step 606, the project bundling team may update a bundling repository in which information about various projects, such as projects that may be bundled with one or more other projects, may be stored.

In step 607, the project bundling team may perform a bundling analysis of the project.

For example, in step 607, the project bundling team may determine whether the project may be bundled with one or more other projects, such as one or more other projects in the bundling repository. In one or more arrangements, the project bundling team may perform this analysis and/or make this determination by performing one or more steps of the method of FIG. 2 (e.g., by identifying commonalities between projects, generating a cost-benefit analysis, etc.).

Referring again to FIG. 6, in step 608, the project bundling team may determine (e.g., based on the bundling analysis conducted in step 607) whether it is possible to bundle the project with one or more other projects. If the project bundling team determines that it is not possible to bundle the project with one or more other projects, then in step 609, the line of business may proceed with the project without bundling the project with any other projects.

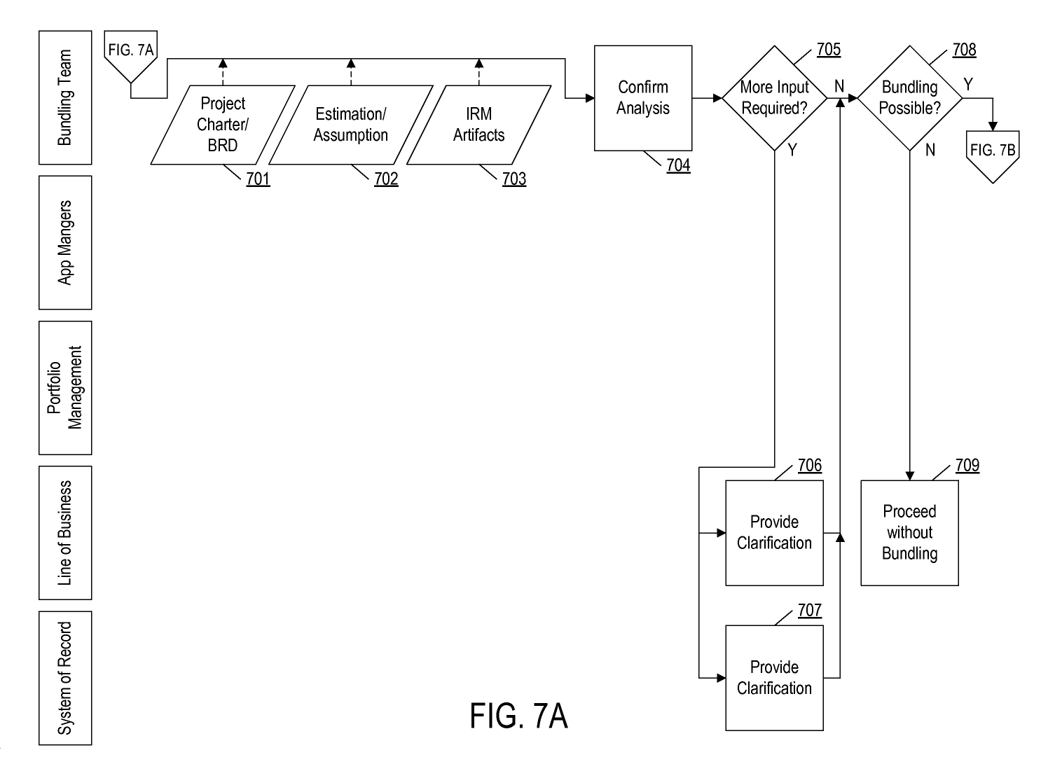

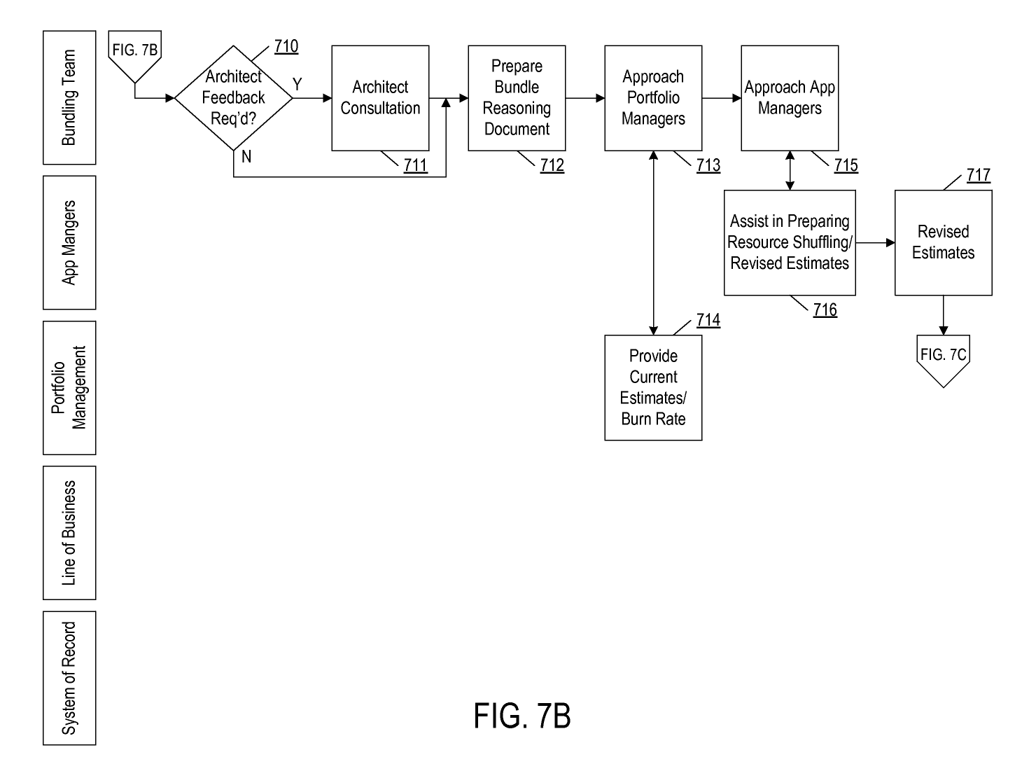

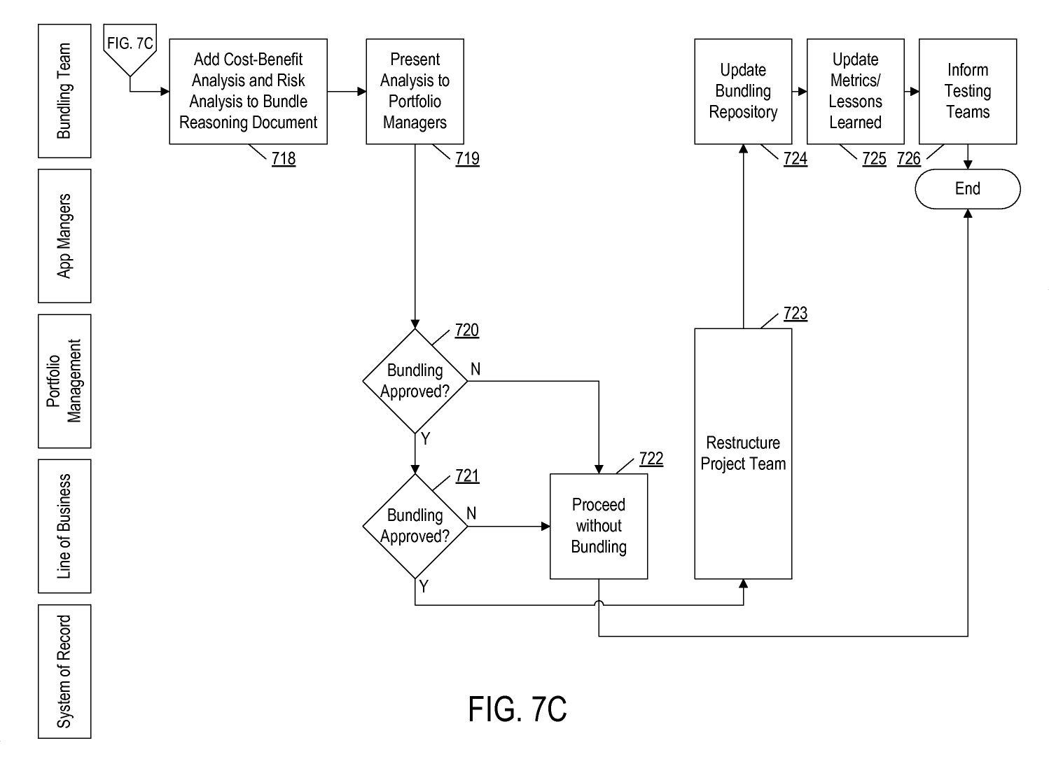

On the other hand, if the project bundling team determines that it is possible to bundle the project with one or more other projects, then in step 610, the project bundling team may monitor a project pipeline and identify the project as active within the project pipeline. The define phase of the project may thereafter be completed (e.g., one or more project documents, such as a high-level definition document and/or a low-level definition document, may be created for the project), and the project may advance to one or more subsequent phases, such as a measure phase, an analyze phase, an improve phase, and/or a control phase. In addition, flow of the example implementation plan may proceed to step 701 of FIG. 7A.

FIGS. 7A-7C illustrate an example implementation plan for managing initiative consolidation after a define phase of a project according to one or more illustrative aspects described herein. As noted above, flow may proceed to step 701, for instance, from step 610 of the implementation plan described above with respect to FIG. 6.

In particular, in step 701 of FIG. 7A, the project bundling team may receive and/or access the project character and/or the business requirements document for the project. In step 702, the project bundling team may receive and/or access one or more documents setting forth estimations of and/or assumptions about various aspects of the project. In step 703, the project bundling team may receive and/or access one or more integrated release management (IRM) artifacts related to the project.

Subsequently, in step 704, the project bundling team may confirm the bundling analysis for the project. For example, in step 704, the project bundling team may again perform a bundling analysis for the project and/or determine whether the project may be bundled with any other projects, as in step 607 described above.

In step 705, the project bundling team may determine whether more input is required in order to make a bundling decision regarding the project. If the project bundling team determines that more input is required, then in step 706, the project bundling team may request, and/or the line of business may provide, clarification of the project. Additionally or alternatively, if the project bundling team determines that more input is required, then in step 707, the project bundling team may request, and/or the system of record (e.g., a system on and/or in which the project and/or its related software may ultimately be deployed, or an individual or team tasked with developing and/or maintaining such a system) may provide, clarification of the project.

If the project bundling team determines that more input is not required in step 705, or after the project bundling team requests clarification in step 706 and/or step 707, the project bundling team may, in step 708, re-determine (e.g., based on the bundling analysis of step 704 and/or further based on the clarification provided and/or received in steps 706 and/or 707) whether it is possible to bundle the project with one or more other projects. If the project bundling team determines that it is not possible to bundle the project with one or more other projects, then in step 709, the line of business may proceed with the project without bundling the project with any other projects.

On the other hand, if the project bundling team determines that it is possible to bundle the project with one or more other projects, then in step 710 (illustrated in FIG. 7B), the project bundling team may determine whether feedback is required from one or more project architects (e.g., because the one or more project architects may be aware of additional information that might impact the bundling decision). If the project bundling team determines that feedback is required from one or more project architects, the in step 711, the project bundling team may request an architect consultation.

Subsequently, or if the project bundling team determines that feedback is not required from one or more project architects, the project bundling team may prepare a bundle reasoning document in step 712. As further described below, the bundle reasoning document may set forth the case for bundling the project with one or more other projects. For example, the bundle reasoning document may describe the commonalities between the project and one or more other projects, the amount of time and/or money that could be saved in testing the project if it were bundled with one or more other projects, and so on.

In step 713, the project bundling team may approach one or more portfolio managers regarding bundling the project with one or more other projects. In step 714, the one or more portfolio managers may provide (e.g., to the project bundling team) current estimates and/or burn rates for the project and/or the one or more other projects with which the project may be bundled, for instance.

In step 715, the project bundling team may approach one or more application managers regarding bundling the project with one or more other projects. In step 716, the one or more application managers may assist the project bundling team in preparing one or more resource shuffling plans and/or in determining one or more revised estimates for various aspects of the project. In step 717, the one or more application managers may provide the revised estimates (e.g., to the project bundling team).

Subsequently, in step 718 (illustrated in FIG. 7C), the project bundling team may add a cost-benefit analysis and/or a risk analysis related to bundling the project with one or more other projects to the bundle reasoning document. In step 719, the project bundling team may present the analysis to one or more portfolio managers.

In step 720, it may be determined whether the one or more portfolio managers have approved bundling the project with one or more other projects. If the portfolio managers approve bundling the project with one or more other projects, then it may be determined, in step 721, whether the line of business has approved bundling the project with one or more other projects.

If either the one or more portfolio managers or the line of business do not approve bundling the project with one or more other projects, then the line of business may proceed with the project without bundling the project with one or more other projects in step 722. On the other hand, if both the one or more portfolio managers and the line of business approve bundling the project with one or more other projects, then in step 723, the line of business and the one or more portfolio managers may collaborate to restructure the project team so as to facilitate the bundling.

Subsequently, in step 724, the project bundling team may update the bundling repository to reflect the bundling of the project with the one or more other projects. In step 725, the project bundling team may update one or more metrics and/or one or more lessons learned documents related to the project, the one or more other projects, the project bundling process generally, and/or the like. In step 726, the project bundling team may inform one or more testing teams of the bundling of the project with the one or more other projects. Thereafter, testing of the bundled project may be performed (e.g., by the one or more testing teams) and the project bundling team may continue analyzing and/or bundling other projects in the project development pipeline.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

1. An apparatus, comprising:
at least one processor; and
memory storing computer-readable instructions that, when executed by the at least one processor, cause the apparatus to:
receive information about at least two new projects;
analyze the received information to identify one or more commonalities between the at least two new projects; and
determine, based on the identified commonalities, to bundle the at least two new projects for one or more testing phases.

2. The apparatus of claim 1, wherein the identified commonalities include one or more common data inputs and one or more common data outputs.

3. The apparatus of claim 1, wherein receiving information about at least two new projects includes extracting, from one or more project design documents, a job listing for each project, wherein each job listing identifies one or more jobs included in each project.

4. The apparatus of claim 3, wherein analyzing the information to identify one or more commonalities between the at least two new projects further includes:
determining, based on the job listing for a first project of the at least two new projects, that a first set of data tables are used as inputs for the first project;
determining, based on the job listing for a second project of the at least two new projects, that a second set of data tables are used as inputs for the second project; and
comparing the first set of data tables with the second set of data tables.

5. The apparatus of claim 3, wherein analyzing the information to identify one or more commonalities between the at least two new projects further includes:
determining, based on the job listing for a first project of the at least two new projects, that a first set of target tables are used as outputs for the first project;
determining, based on the job listing for a second project of the at least two new projects, that a second set of target tables are used as outputs for the second project; and
comparing the first set of target tables with the second set of target tables.

6. The apparatus of claim 1, wherein the memory stores additional computer-readable instructions that, when executed by the at least one processor, further cause the apparatus to:
generate a cost-benefit analysis to calculate potential savings associated with bundling the at least two new projects for the one or more testing phases,
wherein determining to bundle the at least two new projects is further based on determining that the calculated potential savings exceeds a predetermined threshold.

7. The apparatus of claim 1, wherein determining to bundle the at least two new projects is further based on determining that a number of identified commonalities exceeds a predetermined threshold.

8. A method, comprising:
receiving, by a computing device, information about at least two new projects;
analyzing, by the computing device, the received information to identify one or more commonalities between the at least two new projects; and
determining, by the computing device, based on the identified commonalities, to bundle the at least two new projects for one or more testing phases.

9. The method of claim 8, wherein the identified commonalities include one or more common data inputs and one or more common data outputs.

10. The method of claim 8, wherein receiving information about at least two new projects includes extracting, from one or more project design documents, a job listing for each project, wherein each job listing identifies one or more jobs included in each project.

11. The method of claim 10, wherein analyzing the information to identify one or more commonalities between the at least two new projects further includes:
determining, based on the job listing for a first project of the at least two new projects, that a first set of data tables are used as inputs for the first project;
determining, based on the job listing for a second project of the at least two new projects, that a second set of data tables are used as inputs for the second project; and
comparing the first set of data tables with the second set of data tables.

12. The method of claim 10, wherein analyzing the information to identify one or more commonalities between the at least two new projects further includes:
determining, based on the job listing for a first project of the at least two new projects, that a first set of target tables are used as outputs for the first project;
determining, based on the job listing for a second project of the at least two new projects, that a second set of target tables are used as outputs for the second project; and
comparing the first set of target tables with the second set of target tables.

13. The method of claim 8, further comprising:
generating, by the computing device, a cost-benefit analysis to calculate potential savings associated with bundling the at least two new projects for the one or more testing phases,
wherein determining to bundle the at least two new projects is further based on determining that the calculated potential savings exceeds a predetermined threshold.

14. The method of claim 8, wherein determining to bundle the at least two new projects is further based on determining that a number of identified commonalities exceeds a predetermined threshold.

15. At least one non-transitory computer-readable medium having computer-executable instructions stored thereon that, when executed, cause at least one computing device to:
receive information about at least two new projects;
analyze the received information to identify one or more commonalities between the at least two new projects; and
determine, based on the identified commonalities, to bundle the at least two new projects for one or more testing phases.

16. The at least one non-transitory computer-readable medium of claim 15, wherein receiving information about at least two new projects includes extracting, from one or more project design documents, a job listing for each project, wherein each job listing identifies one or more jobs included in each project.

17. The at least one non-transitory computer-readable medium of claim 16, wherein analyzing the information to identify one or more commonalities between the at least two new projects further includes:
determining, based on the job listing for a first project of the at least two new projects, that a first set of data tables are used as inputs for the first project;
determining, based on the job listing for a second project of the at least two new projects, that a second set of data tables are used as inputs for the second project; and
comparing the first set of data tables with the second set of data tables.

18. The at least one non-transitory computer-readable medium of claim 16, wherein analyzing the information to identify one or more commonalities between the at least two new projects further includes:
determining, based on the job listing for a first project of the at least two new projects, that a first set of target tables are used as outputs for the first project;
determining, based on the job listing for a second project of the at least two new projects, that a second set of target tables are used as outputs for the second project; and
comparing the first set of target tables with the second set of target tables.

19. The at least one non-transitory computer-readable medium of claim 15, having additional computer-readable instructions stored thereon that, when executed, further cause the at least one computing device to:
generate a cost-benefit analysis to calculate potential savings associated with bundling the at least two new projects for the one or more testing phases,
wherein determining to bundle the at least two new projects is further based on determining that the calculated potential savings exceeds a predetermined threshold.

20. The at least one non-transitory computer-readable medium of claim 15, wherein determining to bundle the at least two new projects is further based on determining that a number of identified commonalities exceeds a predetermined threshold.
